(19) United States
(12) Patent Application Publication
(10) Pub. No.: US 2010/0309092 A1
(43) Pub. Date: Dec. 9, 2010

(54) CONTACT SPRING FOR PLANAR ANTENNA, ANTENNA AND METHODS

(76) Inventor: Riku Lambacka, Oulu (FI)

Correspondence Address: GAZDZINSKI & ASSOCIATES, PC, 16644 WEST BERNARDO DRIVE, SUITE 201, SAN DIEGO, CA, 92127, US

(21) Appl. No.: 12/864,658

(22) PCT Filed: Jan. 15, 2009
(86) PCT No.: PCT/FI09/50028

§ 371 Date: Jul. 26, 2010

(30) Foreign Application Priority Data
Jan. 29, 2008 (FI) 20085067

(51) Int. Cl. H01Q 1/50

(52) U.S. Cl. 343/906

(57) ABSTRACT

An arrangement for connecting the radiator (430) of the planar antenna of a radio device to the rest part of the device. The arrangement comprises a contact spring (310) with a top contact (318) for making the connection to the radiator and a bottom contact (319) for making the connection to a counter-contact (405) in the radio device. The vertical movement caused by the force which pushes the bottom contact is converted into a rotation, by means of which the top contact of the contact spring is pressed horizontally against a vertical projection (435) of the radiating plane. For implementing the rotation the contact spring is first directed upwards from the bottom contact and turns then back down obliquely. This oblique portion (313) is fixed at its lower end, in which case the pushing of the bottom contact upwards rotates the oblique portion round its lower end. For the top contact, an arm (312) joins the oblique portion (313), which arm at rest is more vertical than the oblique portion and has the top contact (318) at the upper end, and which arm turns together with the oblique portion pressing the top contact to its connection point. The contact spring requires only a relatively small space, because its portions to be bent are substantially vertical, i.e. they have a steep angle in respect of the radiating plane. Though space is saved, the contacts are reliable anyhow. The contact spring is mounted into a box in the dielectric body of the antenna by a snap joint.

The invention relates to an arrangement for connecting the radiator of the planar antenna especially of small-sized radio devices to the rest part of the device. The arrangement comprises a contact spring and the structural parts required for it in the whole antenna.

The internal antennas of the small-sized portable radio devices, such as mobile phones, are most often planar antennas, because they provide good electric characteristics in view of their size. A planar antenna comprises a radiating plane and a ground plane on top of each other, and a feed conductor of the antenna, by which the radiating plane is connected to the transmitter and receiver of the radio device. Most often the planar antenna is of PIFA type (Planar Inverted F-antenna), in which case also a short-circuit conductor joins the radiating plane connecting it to the ground plane. The feed and short-circuit conductors generally function as contacts at least at one end, i.e. they press by spring force against a conductor surface that functions as a counter-contact. The antennas with their contact arrangements are manufactured in large series, for which reason their production costs have to be as low as possible. This means aiming towards a simple structure, which does not require plenty of manufacturing steps. Another requirement relates to the space available: Since most mobile terminals are very small-sized nowadays, also the space available for the antenna is small. This complicates i.a. the manufacture of reliably-functioning contact springs.

In this description and claims, ‘contact’ means a structure part, which has a direct conductive touch with some other conductor. ‘Contact spring’ again means a structure part including at least one contact and a part, which generates the force required for the maintaining the contact connection.

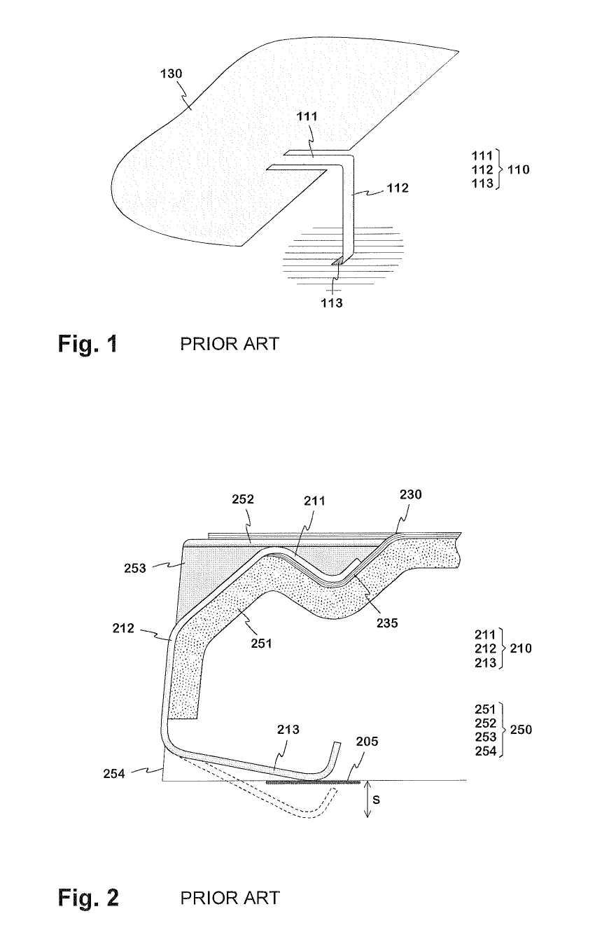

FIG. 1 shows an example of the known contact spring of a planar antenna. The radiating plane 130 and a contact spring 110 are visible in the drawing. In this example these parts are manufactured of a same quite rigid conductor plate so that they are of one and the same object. The contact spring comprises three portions: spring, shaft and contact portions. The spring portion 111 joins the radiating plane and is more or less horizontal, when the geometric plane of the radiating plane is defined to be a horizontal plane. The spring portion continues as the shaft portion 112, which is vertical and extends to the level of the ground plane below the radiating plane. The shaft portion continues as the contact portion 113, which is relatively short and is directed towards the underside of the radiating plane. The strip forming the spring contact then has two bend points. The contact proper is a small skullcap-shaped bulge in the contact portion or a separate pin attached to the contact portion. When the antenna is mounted, the contact is pressed by the spring force of the spring portion 111 against the feed contact of the antenna or the ground plane depending on whether it is the feed or the short-circuit conductor. This kind of solution has the drawback that it requires a relatively expensive production line for sheet metal handling. In practice the manufacture becomes more complicated i.a. for the reason that reinforcing bends and holes have to be made to the shaft portion. Nevertheless, the reliability of the contact leaves something to be desired.

FIG. 2 shows another example of the known contact spring of a planar antenna. In the figure is seen as a section drawing and more than tenfold enlargement the radiating plane 230, contact spring 210, dielectric support structure 250 of the antenna and a counter-contact 205 being located e.g. on the circuit board of a radio device. The contact spring is in this example a bent discrete conductor strip, which comprises in order, starting from the radiating plane, a top portion 211, a middle portion 212 and a bottom portion 213, which constitute a bow with a shape roughly of the letter C. The conductor strip 210 has five bend points, first and second of which are located in the top portion 211. The conductor strip makes a curve downwards in the first bend point and upwards in the second bend point so that a figure of the sign ˜ is formed. A strip 235 branches from the radiating plane, which strip has been bent to the same shape as the top portion of the contact spring. The contact spring is placed on the strip 235 so that it makes a contact to the radiating plane over a relatively long distance. The dielectric support structure of the antenna comprises a part 251, which supports said strip 235 of the radiating plane and the top portion 231 of the contact spring from below, and another part 252, which presses the second bend point in the top portion from above. This way, the contact spring 210 will be locked in its place.

The third bend point of the contact spring 210 is located in its middle portion 212, which runs after the second bend point first obliquely downwards and then almost vertically downwards. Said part 251 of the dielectric support structure follows and supports also the middle portion 212 from inside of the antenna structure. The middle portion ends to the fourth bend point, from which the bottom portion 213 starts obliquely downwards. The tail end of the bottom portion turns upwards forming the fifth bend point of the contact spring, which point functions as a contact. When the antenna is mounted, the fifth bend presses by the spring force the counter-contact 205. The spring force arises from that the contact spring is compressed in vertical direction. In the figure the contact spring has been drawn with a dashed line also at rest. The difference of the heights which correspond to its state of rest and action state, or the stroke s is for example 0.7 mm. The lower surface of the fifth bend can be coated by a material of a precious metal to improve the reliability of the contact.

A drawback of the contact springs like the one in FIG. 2 is that generating a suitable spring force with small tolerance requires a relatively long horizontal dimension of the spring, in which case they take up an inconveniently large space in the radio device. Would the structure be made in a small space, the shaft of the bottom portion and the stroke s would be short, which would mean a relatively wide variation in the production regarding the spring force. In addition, the reliability of the locking of the contact spring is not as good as desired so that it may move away from its place in the course of time. A contact spring like the one in FIG. 2 can also not be implemented in the inner area of the radiator, which would be necessary in some antenna solutions.

The object of the invention is to reduce the above-mentioned drawbacks of the prior art. The contact spring according to the invention is characterized in what is set forth in the independent claim 1. The antenna according to the invention is characterized in what is set forth in the independent claim 5. Some preferred embodiments of the invention are set forth in the dependent claims.

The basic idea of the invention is the following: The contact spring comprises a top contact for implementing the connection to the radiator and a bottom contact for implementing the connection to a counter-contact in the radio device. The vertical movement caused by the force which pushes the bottom contact is converted to a rotation, by means of which the top contact of the contact spring is pressed horizontally against a vertical projection of the radiating plane. For implementing the rotation the contact spring is first directed upwards from the bottom contact and turns then back down obliquely. This oblique portion is fixed at its lower end, in which case the pushing of the bottom contact upwards rotates the oblique portion round its lower end. For the top contact, an arm joins the oblique portion, which arm at rest is more vertical than the oblique portion and has the top contact at the upper end, and which arm turns together with the oblique portion, thereby pressing the top contact to its connection point.

The invention has the advantage that a contact spring according to it requires only a relatively small space. This is due to the fact that its portions to be bent are substantially vertical, i.e. they have a steep angle in respect of the radiating plane. Though space is saved, the strokes are relatively long, which results in that the contacts obtained by the spring structure are reliable anyhow. In addition, the invention has the advantage that the arrangement according to it can be implemented also in the inner area of the radiator. Furthermore, the invention has the advantage that a box of its own can easily be made for a contact spring according to the invention so that it stays firmly in its position. Furthermore, the invention has the advantage that the manufacturing and mounting costs of a contact spring according to it are relatively low. The mounting is based on a simple snap joint.

In the following, the invention will be described in more detail. Reference will be made to the accompanying drawings, in which

FIG. 1 shows an example of the contact spring for a planar antenna according to the prior art,

FIG. 2 shows another example of the contact spring for a planar antenna according to the prior art,

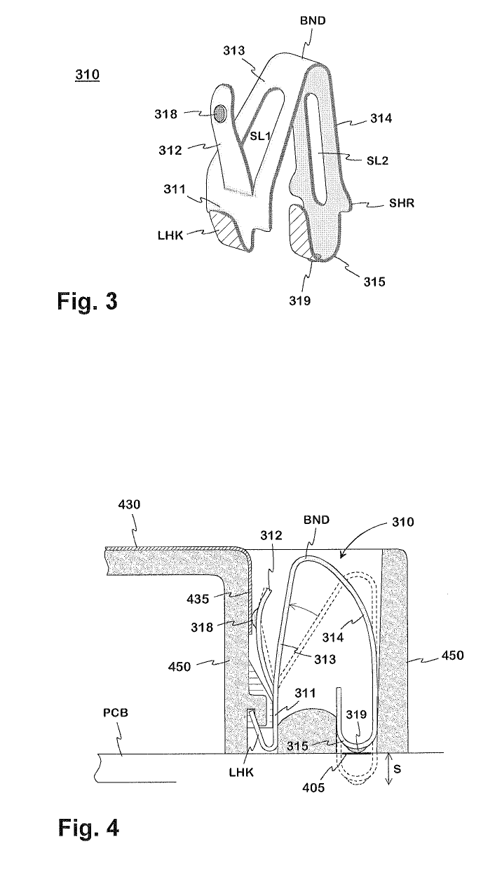

FIG. 3 shows an example of the contact spring for a planar antenna according to the invention,

FIG. 4 shows a contact spring according to FIG. 3 in position in the antenna structure,

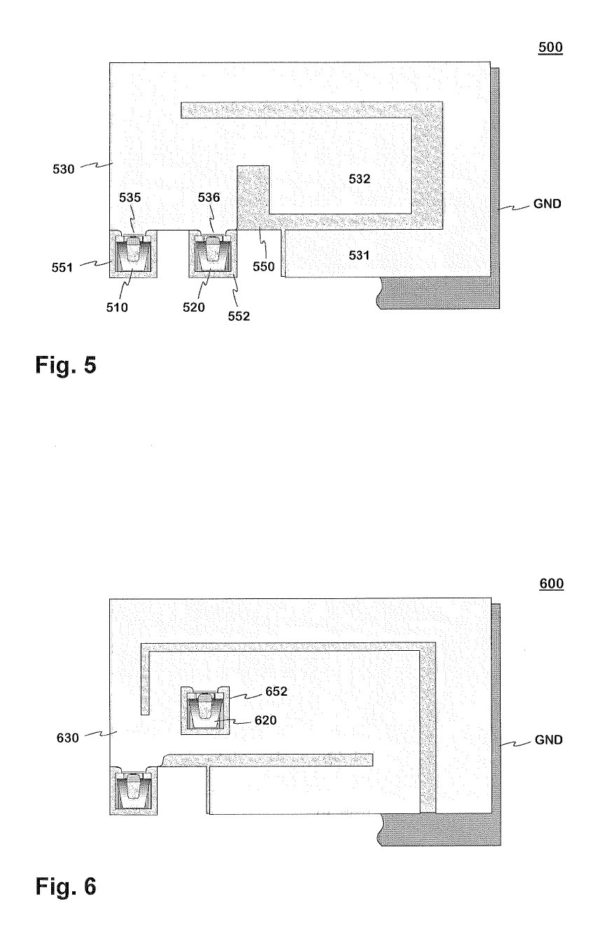

FIG. 5 shows an example of the antenna according to the invention and

FIG. 6 shows another example of the antenna according to the invention.

FIGS. 1 and 2 were already dealt with above in connection with the description of the prior art.

FIG. 3 shows an example of the contact spring 310 for a planar antenna according to the invention. The contact spring comprises a unitary pre-bent metal strip for generating the spring forces, a top contact and a bottom contact. The top contact 318 is intended to be pressed against the antenna radiator and the bottom contact 319 against a counter-contact in the radio device. A contact is constituted e.g. by working a skullcap-shaped projection into a metal plate before bending it and by coating the outer surface of the projection by a precious metal.

The contact spring 310 comprises a portion 311, which is intended to be fixed in the antenna structure so that it can hardly move, when the whole antenna is mounted and the spring portions tense. For this reason said portion to be fixed is called base. The base 311 comprises a vertical part and as its extension a part bent upwards which functions as a locking hook LHK for fixing the base and whole contact spring. The contact spring branches in two at the upper part of the base. The first branch 312 is an arm being directed upwards and bent slightly in the branching point from the direction of the base to the side of the locking hook. Said top contact 318 is located at the upper end of the first branch. Because the top contact is located on an approximately vertical conductor surface, it is suitable for making a connection to another vertical conductor. In the second branch of the contact spring, after the branching point, there is an oblique portion 313, which has been bent from the direction of the base to the opposite side than the first branch 312. Thus there is a certain sharp angle between the oblique portion and the first branch. The first branch is formed by punching a slot with a shape of the sign n to a place of the blank of the contact spring, which place corresponds to the oblique portion, and by bending the arm created in this way to its own direction. A hole SL1 with the shape of the first branch is then left in the middle of the oblique portion.

After the oblique portion 313 there is a bend point BND in the second branch, in which point it turns downwards to a vertical portion 314. In the middle of the vertical portion there is a longitudinal hole SL2, which lightens it and tunes the spring characteristics. At the lower end of the vertical portion there are shoulders SHR extending sidewards, which stop the contact spring to its place, when it is mounted in the antenna structure. As an extension of the vertical portion there is a bottom portion 315 having a shape of the sign U as viewed from the side. Lowest in this bottom portion there is said bottom contact 319, which is then suitable for making a connection to a horizontal conductor.

In FIG. 4 there is the contact spring 310 shown in FIG. 3 in position in the antenna structure. The contact spring, the radiating plane, or radiator 430, the dielectric support structure, or body 450, of the antenna and the circuit board PCB of a radio device, on which the antenna has been mounted, are seen as a section drawing in the figure. The dielectric body 450 forms a frame with vertical walls and a ‘roof’ and a box for the contact spring, the box being open at the top. The radiator 430 is mostly located on the upper surface of the frame. It also comprises a vertical projection 435 extending on the inner surface of said box. In this example the contact spring is fixed to the antenna structure by means of a snap joint by pushing it from above to said box. Compressed, the locking hook LHK of the contact spring then forces its way through a narrow hole in the body. After going through the end of the hook is released and it remains in a recess in the body wall, preventing the contact spring from moving backwards. In this locking state the base 311 of the contact spring leans on some other parts of the body so that it can move neither vertically nor to the side. It can yet turn a little.

In FIG. 4 the contact spring 310 is seen both at rest and in action state, the former being shown with dashed line. The contact spring is at rest, when the antenna has not been mounted on the circuit board. In this case the top contact in the first branch 312 of the contact spring leans lightly on the projection 435 of the radiator, and the bottom contact 319 in the bottom portion 315 is located below the lower level of the antenna structure. The vertical portion 314 of the contact spring is located, seen from the radiator projection 435, against the opposite inner wall surface of said box. When the antenna is pressed against the circuit board PCB, the circuit board presses the bottom contact and pushes the vertical portion 314 upwards the amount of the stroke s. Because the locking hook LHK prevents the whole contact spring from rising from its place, the vertical portion 314 is at the same time forced to bend from the wall of the box towards its middle. This means that the bend point BND of the contact spring moves, and because the lower end of the oblique portion 313 of the second branch can hardly move, the oblique portion turns to more vertical position. This further results in that the oblique portion 313 tries to turn also the base 311 and first branch 312 of the contact spring to the same direction. Because the top contact 318 in the first branch leans on the vertical radiator conductor 435, the first branch only bends and thus presses by its spring force the top contact more firmly against the radiator conductor. In accordance with the above-described, when the contact spring is in the action state, its bottom contact 319 is pressed against the counter-contact 405 on the circuit board by the spring force of the second branch 313, 314, and the top contact 318 is pressed against the radiator projection 435 by the spring force of the first branch 312.

The central feature in the contact spring according to the invention is that its portions to be bent, or the first branch 312 and the oblique portion 313 and vertical portion 314 of the second branch, are substantially vertical. ‘Substantially vertical’ means here that the straight line between the starting and end points of said portions has a steep angle in respect of the plane of the radiator. The steep angle again means the range of 90±40 degrees. The vertical direction results in that relatively long strokes and thus reliable contacts are achieved by means of the spring structure, although it fits in a relatively small space.

FIG. 5 shows an example of the antenna according to the invention. The antenna 500 is shown from above. It comprises a radiating plane 530 on the upper surface of the dielectric body, as in FIG. 4, the ground plane GND below the radiating plane, the feed conductor and the short-circuit conductor, which connects the radiating plane to the ground plane. The antenna 500 is then of PIFA type. The radiating plane comprises two branches 531, 532 for implementing two operating bands.

Both the feed and short-circuit conductors are constituted by means of the contact springs according to the invention, the feed conductor by the first contact spring 510 and the short-circuit conductor by the second contact spring 520. They are located at an edge of the radiating plane on the area, which is shared between the said branches 531, 532 of the radiating plane. For the first contact spring 510, to fix and support it, there is a first box 551 in accordance with FIG. 4 belonging to the dielectric body of the antenna. Seen from above, the vertical walls of the box form a rectangle. The top contact in the first branch of the first contact spring 510 is pressed against the projection 535 of the radiating plane extending on the inner surface of the first box, like the top contact 318 in FIG. 4. For the second contact spring 520 there is an identical box 552. A second projection 536 extends on the inner surface of this box, the second contact spring making a short-circuit to the ground plane GND through that projection 536.

FIG. 6 shows another example of the antenna according to the invention. The antenna 600 is in principle similar to the one in FIG. 5. A remarkable difference to the antenna 500 is that the contact spring 620, by means of which the short-circuit conductor of the antenna is constituted, is now not located at an edge of the radiating plane 630 but on its inner area. On that area between the radiating plane and the ground plane there is a box 652 like the ones described before for the contact spring 620. Naturally, there is a hole in the radiating plane with the size of about the cross-section of the box, for mounting the contact spring.

In this description and the claims, the qualifiers ‘upper’, ‘top’, ‘lower’, ‘bottom’, ‘horizontal’ and ‘vertical’ refer to the position of the antenna, in which its radiating plane is horizontal and above the ground plane. Correspondingly, said qualifiers refer to the position of the contact spring in an antenna having such a position. The use position of a radio device, in which the antenna is located, can naturally be any.

An arrangement according to the invention for connecting the antenna radiator to the rest of a radio device has been described above. The contact spring belonging to the arrangement can vary in detail from the one presented. For example, its fixing at its base part can instead of the snap joint be e.g. one, which is based on a discrete fixing means. An antenna according to the invention is naturally not limited to the cases shown in FIGS. 5 and 6; for example the shape of the radiator can vary widely. The antenna can also have only one contact spring, whereupon it is a case of an ILA (Inverted L-Antenna) of planar type. The invention also does not limit the way of manufacturing of the antenna. The inventive idea can be implemented in different ways within the limits set by the independent claims 1 and 5.

1.-7. (canceled)

8. A spring contact apparatus for use with an antenna of a radio device, the spring contact apparatus comprising:
a pre-formed metal element, comprising:
a base portion;
a first branch comprised of a first contact element, the first contact element configured to be coupled to a coupling element of the antenna along a first plane; and
a second branch comprised of a second contact element, the second contact element configured to be coupled to an interface of the radio device along a second plane;
wherein the first plane and the second plane are not parallel with one another.

9. The apparatus of claim 8, wherein said second branch further comprises a first arm, a second arm, a bend transition portion formed between the first arm and the second arm and a bottom portion;
wherein the first arm is arranged to extend substantially upwards towards the bend transition portion;
wherein the second arm is arranged to extend substantially downwards from the bend transition portion towards the bottom portion; and
wherein the bottom portion comprises the second contact element.

10. The apparatus of claim 9, wherein the first arm further comprises a first aperture having a perimeter that is substantially similar to an outline of the first branch.

11. The apparatus of claim 9, wherein the second arm further comprises a second aperture arranged longitudinally along an axial dimension of said second arm.

12. The apparatus of claim 9, wherein the first branch is arranged to extend substantially upwards from the base portion at an angle with respect to the first arm.

13. The apparatus of claim 8, wherein the base portion further comprises a locking element configured to interface with a support structure within the radio device.

14. The apparatus of claim 13, wherein the locking element forms a snap-fit joint with the support structure.

15. The apparatus of claim 8, wherein said second branch further comprises a first and second portion and a transition portion formed between the first and the second portions;
wherein the first portion extends substantially towards the transition portion; and
wherein the second portion extends substantially from the transition portion.

16. A planar antenna for use in a radio device, comprising:
a dielectric element comprising a first surface and a second surface;
a coupling element arranged at least partially on the first surface;
a radiating element electrically coupled to the coupling element and disposed at least partly on the second surface; and
a first spring contact apparatus, comprising:
a first contact element coupled with the coupling element;
a second contact element configured to be coupled to an interface of the radio device; and
a spring element, comprising:
a base;
a first section comprised of the first contact element; and
a second section comprised of the second contact element;
wherein the interface of the radio device is arranged at least partly along a third surface, the first surface being non-parallel with the third surface.

17. The antenna of claim 16, wherein the second section comprises a plurality of bends resulting in a first arm, a second arm and a bottom portion, the bottom portion comprised of the second contact element.

18. The antenna of claim 17, wherein the base further comprises a locking element that extends from the base, the locking element configured to affix the base to a support structure.

19. The antenna of claim 18, wherein the support structure is arranged along the first surface.

20. The antenna of claim 16, wherein the dielectric element further comprises at least one aperture configured to receive the first spring contact apparatus;
wherein the coupling element is disposed substantially on an inner surface of the aperture.

21. The antenna of claim 20, wherein the planar antenna further comprises a planar inverted-F antenna configuration.

22. A planar antenna according to claim 16, further comprising:
a second contact spring apparatus;
a feed point; and
a short-circuit point;
wherein the first spring contact apparatus is configured to couple the feed point to an antenna feed port of the radio device; and
wherein the second spring contact apparatus is configured to couple the short-circuit point to a signal ground port of the radio device.

23. A method of forming an electrical connection between a coupling element of a planar antenna and an electrical interface of a radio device, the method comprising:
providing an antenna radiating element, the radiating element arranged at least partly within a first plane;
arranging at least a portion of the coupling element within a second plane;
electrically coupling the radiating element to the coupling element;
arranging the electrical interface of the radio device at least partly within a third plane;
providing a spring contact apparatus;
affixing the spring contact apparatus to a support structure of the radio device via the locking element; and
rotating a spring element associated with the spring contact apparatus along an axis that is coplanar to the second plane.

24. The method of claim 23, wherein the act of rotating provides a first electrical connection between a first contact element of the spring contact apparatus and the coupling element and a second electrical connection between a second contact element of the spring contact apparatus and the electrical interface of the radio device, respectively; and
wherein said second plane is arranged so as to be non-parallel with the third plane.

25. A contact spring for a planar antenna that connects a radiator of the antenna to a radio device, the contact spring comprising:
a pre-bent metal strip;
a top contact configured to be pressed against the radiator and a bottom contact configured to be pressed against a counter-contact in the radio device;
wherein the pre-bent metal strip comprises a base configured to be fixed to a dielectric body of the antenna, the metal strip comprising a first and a second branch, the first branch comprising an arm directed upwards from the base and having the top contact at its upper end;
wherein the second branch comprises, in order, an oblique portion being directed upwards from the base, a bend point, a vertical portion being directed downwards and a bottom portion comprised of the bottom contact; and
wherein the first branch, the oblique portion and the vertical portion of the contact spring to are substantially vertical with respect to a plane of the radiator.

26. The contact spring of claim 25, wherein a portion bending upwards in the lower end of the base which forms a locking hook; and
wherein the base is arranged to be fixed to the dielectric body of the antenna via a snap joint.

27. The contact spring of claim 25, further comprising a hole in the oblique portion, the hole starting from the lower end of the first branch and corresponding in shape to the first branch.

28. The contact spring of claim 25, further comprising a longitudinal hole in the vertical portion, the longitudinal hole tuning the spring characteristics of the vertical portion.

29. A planar antenna, comprising:
a supporting dielectric body;
a radiating plane on an upper surface of the supporting dielectric body; and
at least one contact spring that connects the radiating plane of the antenna to a radio device, the at least one contact spring comprising:
a pre-bent metal strip;
a top contact configured to be pressed against the radiating plane and a bottom contact configured to be pressed against a counter-contact in the radio device;
wherein the pre-bent metal strip comprises a base configured to be fixed to the supporting dielectric body of the antenna, the metal strip comprising a first and a second branch, the first branch comprising an arm directed upwards from the base and having the top contact at its upper end;
wherein the second branch comprises an oblique portion being directed upwards from the base, a bend point, a vertical portion being directed downwards and a bottom portion comprised of the bottom contact; and
wherein the first branch, the oblique portion and the vertical portion of the contact spring to are substantially vertical with respect to the radiating plane.

30. The planar antenna of claim 29, wherein the dielectric body comprises for each contact spring:
a box being open at the top with the radiating plane comprising a projection extending to an inner surface of one vertical wall of the box so that the top contact of the contact spring is pressed against this projection by the spring force of said first branch when the antenna has been mounted.

31. The planar antenna of claim 30, wherein the number of contact springs is two with a feed conductor of the antenna being implemented with a first contact spring and a short-circuit conductor being implemented with the other contact spring.

32. A radio device, comprising:
a radio transceiver; and
a planar antenna in communication with said transceiver via an interface, the antenna comprising:
a dielectric element comprising a first surface and a second surface;
a coupling element arranged at least partially on the first surface;
a radiating element electrically coupled to the coupling element and disposed at least partly on the second surface; and
a first spring contact apparatus;
wherein the interface is arranged at least partly along a third surface, the first surface being non-parallel with the third surface.

33. The radio device of claim 32, wherein the spring contact apparatus comprises:
a first contact element coupled with the coupling element;
a second contact element configured to be coupled to the interface; and
a spring element, comprising a base, a first section comprised of the first contact element, and a second section comprised of the second contact element.
